(19) United States
(12) Patent Application Publication
(10) Pub. No.: US 2022/0067694 A1
(43) Pub. Date: Mar. 3, 2022

(54) INSTANT MONEY TRANSFER METHODS AND SYSTEM FOR IMPLEMENTING SAME

(71) Applicant: AKCIONERNOE OBSCHESTVO "NACIONAL'NAYA SISTEMA PLATEZHNYKH KART", Moscow (RU)

(72) Inventors: Evgenij Georgievich SOLOV'EV, Moscow (RU); Dmitrij Aleksandrovich KOLESNIKOV, Moscow (RU); Natal'ya Olegovna PETUSHKOVA, Moscow (RU)

(21) Appl. No.: 17/416,800

(22) PCT Filed: Dec. 24, 2019
(86) PCT No.: PCT/RU2019/001005

§ 371 Date: Jun. 21, 2021

(30) Foreign Application Priority Data
Dec. 24, 2018 (RU) 2018145943

(51) Int. Cl. G06Q 20/32

(52) U.S. Cl. CPC G06Q 20/3223; G06Q 20/3255

(57) ABSTRACT

The claimed group of inventions pertains to IT within the finance industry, notably the automated methods and system for interbank funds transfers from a bank account of one individual to a bank account of another individual using a known social identifier of the funds recipient, without indicating the actual account number of the customer or the details of their payment instrument, as well as funds transfers between two or more bank accounts of the same individual opened with different financial institutions, whose system includes: communication devices of the Sender and the Recipient, computation systems of the Originator bank and the Destination bank, the central server component, the settlement system and the notification service, 3 primary claims, 7 subclaims, FIG. 5.

### PERTINENT ART AND BACKGROUND OF INVENTION

The claimed invention pertains to IT within the finance industry, notably the automated methods and system for interbank funds transfers from/to an account wherein a funds sender does not know a recipient's bank account number or PAN.

At present, funds are transferred from one individual to another using the following known methods:

1. the traditional inter- or intrabank transfer using a bank payment order made either in writing against presentation of a sender's proof of identity or (remotely) as an e-document if the sender's identity has been previously proven and they have means of electronic identification at the time of transaction (e.g., via customer's on-line or mobile bank). This transfer method means that funds flow within the infrastructure of one or two credit institutions, and in case of interbank transfer, the settlement agent transfers funds between these credit institutions during a predefined settlement period;

2. the funds transfer via one of the commercial money transfer providers, which is also made either in the presence of the funds sender in a point of service (in a bank branch or affiliate) against presentation of a sender's proof of identity or remotely if the sender's identity has been previously proven and they have means of electronic identification at the time of transaction. From the sender's and recipient's perspective, the transfer is instantaneous. However, banks do not settle with each other instantly, but only at points in time (usually once a day), when settlement totals are summarized and provided to the settlement agent (bank) for the actual funds transfer from one bank to another;

3. the funds transfer from a sender's bank card to a recipient's bank card performed via payment systems wherein a card is a financial instrument. Such funds transfer is performed using secure authentication of a sender, regardless of the transaction infrastructure. Thus, if a transaction is performed via an ATM, the sender must physically present the card and enter PIN (personal identification number). If a transaction is performed on the Internet, the sender must enter their PAN as well as a secret code sent by their Issuing bank via any alternative communication channel, e.g., as a text message. It is clear that in the two examples above, the sender indicates the recipient's PAN in order to provide information about who should actually receive the funds. Such transaction can be both interbank and intrabank. The interbank settlement is also performed once within a strictly determined period. Therefore, if a recipient needs to immediately use the funds transferred, they may experience difficulties due to the fact that the funds would not actually have been credited to their account.

Due to the fact that such funds flow methods are inconvenient for both credit institutions and individuals, other methods of funds transfers have been created in the last decade which address the issue of transfer speed by including institutional authorities acting as settlement systems (typically, central banks) into the system whereon funds transfer methods are implemented.

It should be noted that interbank transfers from a sender's account with one bank to a recipient's account with another bank are not instantaneous. They are governed by the practice of accumulating requests for such transfers from senders and then forwarding them to settlement systems. Settlement systems work on the principle of totals settlement. This means that requests are first grouped, and settlements (the actual flow of funds between banks) are performed not individually for each transfer request but for the total amount generated once every predetermined period, typically, once a day.

To address the issue of funds transfer speed, the EARLY WARNING SERVICES LLC (US) company, the applicant of discovery application US20180121975 dated May 3, 2018, proposed a technical solution describing a system of payments from an account with one bank to an account with another bank. This system is designed to pay invoices issued by the Destination bank to the Originator bank in real time. The essential attributes of specified payments in real time are:
payments are made against issued invoices;
such payments do not require a third party embodied in a settlement system (a country's central bank) since the Originator bank sends a promise-to-pay message, i.e. they are not, by nature, a flow of funds but a flow of payment promises (guarantees);
the transfer results in crediting of a recipient's account by the second bank at the time of promise-to-pay message receipt;
an incentive is provided for payments made “on time”;
a provision is made for a reward;
a “Recommended billing bank” is selected, which must be certified and assigned a Public Identifier;
granting a credit to the payer is provided involving a determination of their location with a preliminary analysis of the payer's account balance.

However, based on the analysis of the solution, its implementation does not result in quick crediting of funds to the recipient's account. Only the exchange of guarantees between credit institutions that credit and debit accounts of their customers, respectively, is instantaneous. The inability to transfer funds also stems from the absence of a settlement agent or another organization (system component) which would act as a regulator and perform settlement directly between credit institutions. In addition, to implement the proposed solution, the receipt of a special Public Identifier becomes mandatory for a credit institution, which additionally indicates the need to undergo special certification of the credit institution infrastructure to confirm compliance with the system requirements.

The involvement of settlement systems can help ensure the immediacy of settlements not only between the sender and recipient of funds, but also between the Originator bank and Destination bank, so that there are no attributes of hidden crediting by the beneficiary bank of its customer acting as a recipient. Thus, a number of countries and even a number of international alliances saw the emergence of systems for instant payments between accounts. For instance, SEPA Credit Transfer and SEPA Instant Credit Transfer were created in the EU. If a bank customer acting as a sender indicates their direct unique IBAN and the direct unique account IBAN of the recipient and the transfer amount, such system will perform the transfer (subject to secure authentication of the sender) close to real time.

In addition, a technical solution is known that provides for a settlement system when performing funds transfers from one account to another, namely patent for invention No. JP5959578B2 published on Feb. 2, 2016 held by SUMITOMO MITSUI BANKING CORP, which is a system and methods for funds transfer additionally implemented within the infrastructure of RTGS (Real Time Gross Settlement) settlement system of the Bank of Japan.

RTGS allows for the settlement of each individual transaction, where transactions enter the RTGS system one by one, and is designed to enable the end user (customer) to make payments (initiate them in RTGS) without the assistance of representatives of the bank with which their account is opened. That is, a system is proposed to carry out a dialog with the RTGS system via remote access established using a separate server system for a customer of any Japanese bank to transfer funds. The system allows the end user (a customer of a certain bank who can be both an individual and a legal entity) to set a personal payment schedule, i.e. date and time of settlement, payment, and, as a result of the interaction, the management server linked to another server on the side of the bank wherein the customer's account is opened, and the RTGS system, performs the funds transfer according to the payment schedule initiated by the customer.

The downside of this system is the fact that its implementation does not involve a mandatory request to the server by the beneficiary bank for additional verification of the data on the recipient entered by the sender at the time of transfer initialization, which would certify that the recipient is indeed the customer of the beneficiary bank, so there remains a high probability of incidents related to the transfer of funds to the wrong recipient.

In addition, nowadays, when each individual has numerous bank accounts and is issued numerous bank cards, it is not safe to transfer data about them to third parties. The issue not addressed in invention JP5959578B2, which is to increase the speed of funds transfers using identifiers other than bank details of the recipient's account, is growing more urgent. These and other issues can be solved by implementing the invention claimed by the applicant.

### SUMMARY

This group of inventions is aimed at solving the task of increasing the speed of funds transfers from the bank account of one individual to the bank account of another individual using a known social ID of the recipient without indicating the actual account number of the customer or the details of their payment instrument, as well as increasing the speed of transfers between two or more of individual's own bank accounts with different financial institutions.

The technical result of the claimed invention is the increase in speed of interbank transfers.

Social IDs are identifiers that can be known by the general public, e.g., phone number, e-mail address, social network nickname, as well as others that serve to identify the sender and recipient of funds. To use these identifiers, the customer must communicate them to the bank with which they have opened account(s). The customer must be securely authenticated by their bank. In this case, the bank can associate these identifiers to one specific bank account chosen by the customer.

In addition, an important advantage of the claimed invention is the fact that the high speed of funds transfer can be achieved between customers of different banks, while the recipient can select the bank and the default account opened therewith to which they want to receive funds.

In accordance with this invention, the interbank funds transfer system can be represented by communications devices of the Originator and the Destination, e.g., user smartphones with payment applications installed, banking computation systems of the Originator bank and the Destination bank, the central server component, including but not limited to the database, script module, interface modules, notification service, which can be located separately from the central server component, as well as the settlement system allowing for the flow of funds during the high speed transfer.

In the first option of the automated method for funds transfer, the implementation allows for interbank funds transfer from one account to another between individuals where the sending individual does not know the actual account number of the receiving individual.

The second option of the implementation describes the automated method for interbank funds transfer from one account to another where the Sender and the Recipient are the same individual.

### BRIEF FIGURES DESCRIPTION

A number of figures are given to showcase the system and method implementation:

FIG. 1 is a diagram showing the high-level architecture of the funds transfer system;

FIG. 2 is a sequence diagram for determining the payment details of the Recipient;

FIG. 3 is a sequence diagram for verifying the payment details of the Recipient;

FIG. 4 is an operational sequence for the transfer of funds;

FIG. 5 displays the scheme and procedure for funds transfer between the accounts of one individual.

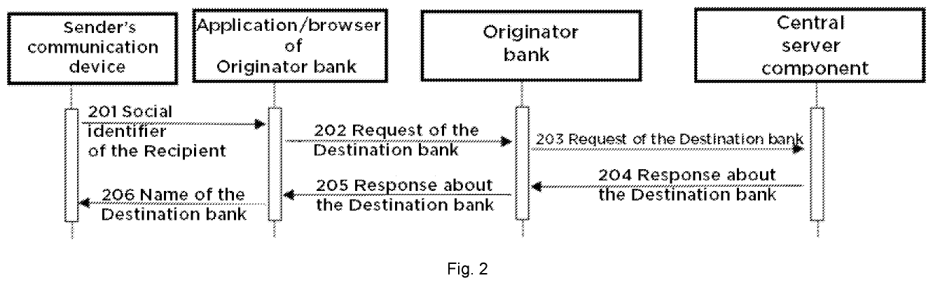

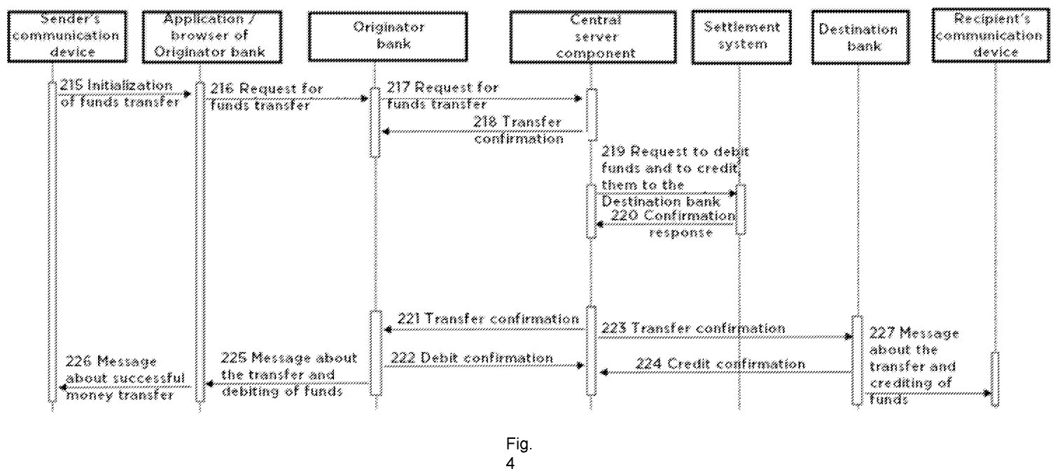

Vertical lines in FIGS. 2-5 show steps and actions performed over time.

### DETAILED DESCRIPTION

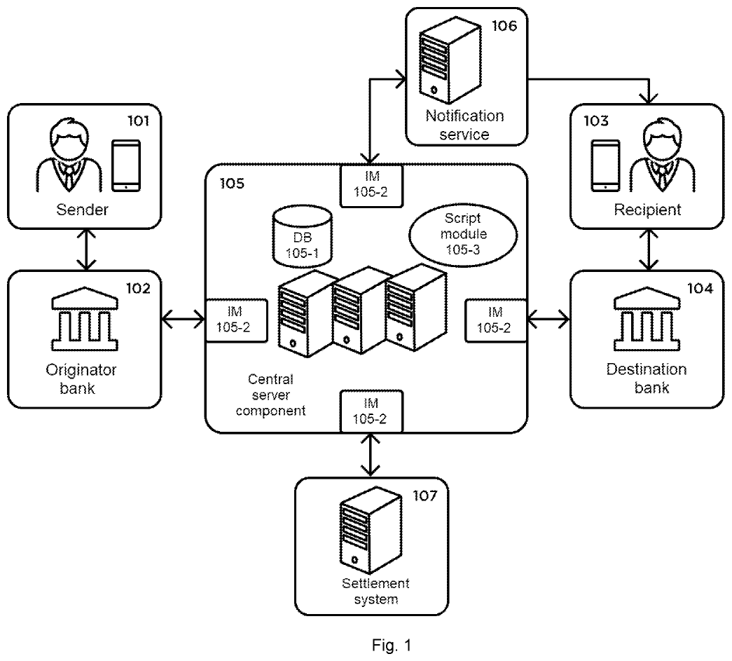

The architecture of the system components is based on a bilateral model, the parties to which are the Sender and the Recipient of funds. Moreover, each party is assigned a financial institution - a bank servicing its customer (a party), hereinafter referred to as the Originator bank and the Destination bank. It is showcased in FIG. 1, which shows components that carry out the interaction between the parties, namely:
Sender's communication device (101) which can be a smartphone, tablet, smart watch, smart glasses, computer (including portable), set-top box, whose performance specifications allow using additional software (an application or a browser) and connected to the Internet (to access payment services, personal bank accounts, and online services);
the Originator bank (102) represented in one or more computation systems programmed to perform functions described in more detail below, containing, among other things, databases, notification services and possibly other components. The computation system is configured to include the option of online customer service;
Recipient's communication device (103) which can be a smartphone, tablet, smart watch, smart glasses, computer (including portable), set-top box, whose performance specifications allow using additional software (an application or a browser) and connected to the Internet (to access payment services and receive information on the crediting of funds to the current account, as well as personal bank accounts, and online services);
the Destination bank (104) represented in one or more computation systems programmed to perform functions described in more detail below, containing, among other things, databases, notification services and possibly other components. The computation system is configured to include the option of online customer service;
the central server component (105) that takes the form of one or more computation systems programmed to perform functions described in more detail below, containing, among other things, a database (105-1), a script module (105-3) and interface modules (105-2). The script module is a program that receives messages from interface modules and performs all reasonability checks (semantic validations) of all incoming messages, determines their purpose and validity, checks the timeliness of their receipt, saves the processing results to the database, and forwards messages to interface modules for sending.

Interface modules are programs that perform the following functions:

1) receiving messages from specialized communication channels, automatically retrieving them, monitoring their integrity and checking them for technical errors, transferring them to the script module for application processing and simultaneously transferring to the sender successful or failed delivery notifications;

2) receiving messages from the script module, filing messages into a selected specialized communication channel and sending them to recipients, receiving successful or failed delivery notifications.
the notification service (106) is a hardware and software system that can be either integrated into the central server component or remain stand-alone. It is one or more computation systems connected via communication channels with communication devices of the funds sender or recipient, and a database;
the settlement system (107) is a hardware and software system, one or more computational servers, containing, among other things, a funds distribution module responsible for actual funds transfer between banks. The funds distribution module is a program that changes values of the amount of funds on settlement accounts.

Among other things, similar to the description of the central server component, computation systems of Originator and Destination banks, of notification service and settlement system can include their own script modules, interface modules and other programs performing similar functions required for reasonability checks (semantic validations) of messages coming into computation systems, as well as to transfer messages to modules for sending, which will accept messages from specialized communication channels, from other system components, retrieve them from transport formats, control their integrity and check for transport errors.

All system components shown in FIG. 1 have gateways to communicate with each other via specialized communication channels that meet the security requirements for the performance of payment transactions. To simplify the visualization of the system, communication gateways are not shown among the components, but it is obvious that they are required for messaging.

Messages containing parameters defined by the methods are generated, sent, received and processed using system and application software.

In order to implement the first automated method for funds transfer, the individual acting as the funds Recipient (using their communication device and software installed thereon) launches the application of a bank with which they have an account or contacts a server via an application or a browser and communicates their credentials required to receive funds, namely:

1. informs the bank that the Recipient wishes to receive funds transfers to their account in this bank;

2. if the Recipient has several settlement accounts with the bank, then they must select the settlement account to credit funds to;

3. communicates to the bank their social identifiers, e.g., phone number or e-mail address, which the bank will use to identify them. The Recipient decides which identifier to use for the system and methods, and such identifiers are not limited to the phone number or e-mail address, but can also be a login or username in the banking app, a nickname etc.;

When the Recipient has accounts with different banks, they perform the described actions via their communication device and software installed thereon, launch applications of other banks or contact them via an application or a browser, and repeat the procedure of items 2-3.

The Destination bank, upon verifying the information provided by the Recipient, sends to the central server component a message that the Recipient, under a certain social identifier, has selected it as the default bank to receive funds. If necessary, e.g., when a Recipient has previously provided information to another bank, including selecting the default bank to receive funds. The central server component, by contacting the notification service, sends a request to the Recipient to confirm the selection of the default bank. Such request can be generated and sent as a text message or through other means of messaging.

Steps described above are preparatory actions necessary to speed up funds transfers using the system components specified.

FIG. 2 shows the operational sequence consisting in the data flow between system components and aimed at the Sender's selection of the Destination bank. It must be noted that the definition of the “Destination bank” also means the selection of bank details of the Recipient to transfer funds, such as, for example, the Recipient's account number with the bank to which funds must be credited if the transfer is successful.

For instance, the Sender is shown to launch the software (the application of the bank with which they have an account or the bank's website in a browser) installed on their communication device, e.g., a smartphone. In the Recipient field, the Sender enters (201) a social identifier known to them, e.g., the Recipient's phone number, using the application with the bank's server and conveys the wish to transfer funds to another individual.

In other words, at the time of entering the Recipient's social identifier, an information exchange (202) takes place between the Originator bank software installed on the Sender's smartphone and the Originator bank computation system, as well as between the Originator bank (203) and the central server component, in order to determine the Destination bank. At the time of this message exchange, it is implied that the Recipient has done all the preliminary steps to provide their social identifiers, selected the bank acting on their behalf as a Destination, and the bank has provided the received information to the central server component to store the Recipient information in the central server component database.

When receiving a request to select the Destination bank (203), the central server component sends a request response (204) containing the attribute of the presence or absence of data on the Destination bank, which is sent back (205, 206) via the Originator bank to the software to be displayed to the Sender so that they can decide whether to continue transferring funds to the Recipient. In case if the Recipient informed the Sender in advance of the bank they have an account with to which they wish to receive funds, the Sender, having received a response to their first request about the Destination bank, can still select the bank required by the Recipient from the list in the software.

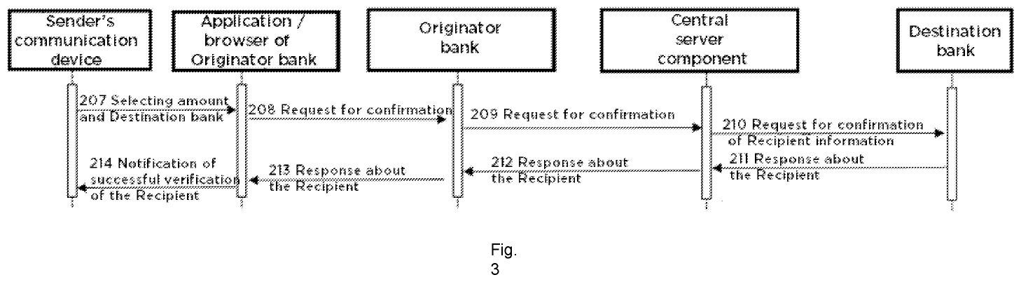

When the Sender learns the name of the Destination bank and they agree to proceed with the transfer, the next stage in the exchange of information messages takes place, shown in FIG. 3.

Thus, the data about the transfer amount, the Recipient's social identifier and the name of the Destination bank are put (207) into a message sent via the software (208) to the computation system of the Originator bank and then (209) to the central server component. The central server component sends a request (210) containing this data to the Destination bank in order to receive the validation of transfer.

The computation system of the Destination bank processes the request (210) and generates the request response (211) to the central server component, which includes the information about the Recipient and their account, e.g., the Recipient's Last name, First name and Patronymic and other information about them.

The central server component creates a challenge phrase out of the First name, Patronymic and the first letter of the Last name of Recipient, which it adds to the transferred information. This example of challenge phrase conversion is given because using the Recipient's First Name, Patronymic and the first letter of the Last name for the Sender to verify the Recipient's identity is a known verification method and it is generally accepted in the banking industry. However, over time, other methods of Recipient's identity verification may apply, and the use of new challenge phrases will not affect the implementation of claimed methods.

All of the information listed returns (212) to the Originator bank, and the software on Sender's communication device (213) receives and displays (214) the challenge phrase.

If the Destination bank does not verify the Recipient's data (social identifier), a notification of failed verification is generated and sent (211, 212, 213). Consequently, the Sender is shown a notification of failed transfer attempt, and they can restart the transfer from step 201 and select a different Destination bank at step 207.

Nevertheless, when at step (214) the Sender receives a message with the successful attribute, it is proposed to initialize the funds transfer (215) itself For example, the software in its interface on the Sender's communication device may prompt the Sender to click “Transfer” or “Next”.

This invention does not address the particular user interface characteristics of applications or payment services that can be accessed using a browser (provided only as an example).

Upon initialization of a funds transfer (215), a funds transfer request (216) is generated via the software on Sender's personal communication device to the computation system of the Originator bank, which is then forwarded (217) to the central server component, which in turn processes it. Once it is completed successfully, the central server component sends a message (218) confirming readiness to perform a transaction to the Originator bank and generates a financial request (219) to the settlement system about debiting the funds from the Originator bank account and crediting them to the Destination bank account.

The settlement system performs the financial request indicated by the central server component and sends a message (220) confirming its performance.

After receiving confirmation of the funds transfer performance, the central server component sends corresponding messages (notifications) of successful transfer completion:

1. to the Originator bank (221), which, having received the confirmation from the central server component of the transfer performance and debiting of funds from its account, debits them from the account of its customer, the Sender of the transfer, and then sends the notification (222) confirming the debiting to the central server component;

2. to the Destination bank (223), which, having received the confirmation from the central server component of the funds transfer performance and their crediting to its account, credits them to the account of its customer, the Recipient, and then sends the notification (224) confirming the crediting to the central server component.

Thus, this implementation of this automated method for interbank funds transfer entirely excludes the possibility of “hidden” crediting of customer accounts by banks.

Once the Originator bank has sent to the central server component the notification (222) mentioned above confirming the debiting, the Originator bank's computation system generates and sends (225, 226) a message of successful transfer and debiting of funds to be shown to the Sender. Similar actions are performed by the Destination bank, which, having credited the funds to the Recipient's (its customer's) account and sent the notification thereof to the central server component (224), sends (227) a message to the Recipient of the crediting of funds.

In addition to the notification to the Recipient of the funds crediting, sent by the Destination bank, the central server component can in turn send a notification to the Recipient of the crediting of funds by sending a request to the computation system of the notification server. In response to the request of the central server component, the notification server sends a message to the Recipient's communication device using any method supported by its components, for example, sending a text message (in case if the Recipient has provided it earlier as a social identifier) or an e-mail (in case if the Recipient has provided their e-mail address earlier as a social identifier), as well as via other known means of communication.

Thus, the claimed automated method for interbank funds transfer eliminates the shortcomings of the previous methods due to the fact that the settlement system component included into the claimed system performs funds distribution, instead of banks themselves previously having to send requests to debit and credit funds to the settlement system, e.g., to the Central Bank of the Russian Federation. At the same time, all the requirements to generation and verification of funds transfers are met, including the provision of all necessary payment details for such transfers. It is essential that the obligation to provide all of these details is shifted from the funds Sender (an individual) to the Originator bank and Destination bank, which simplifies the transfer for its Sender and reduces the likelihood of various mistakes when entering payment details.

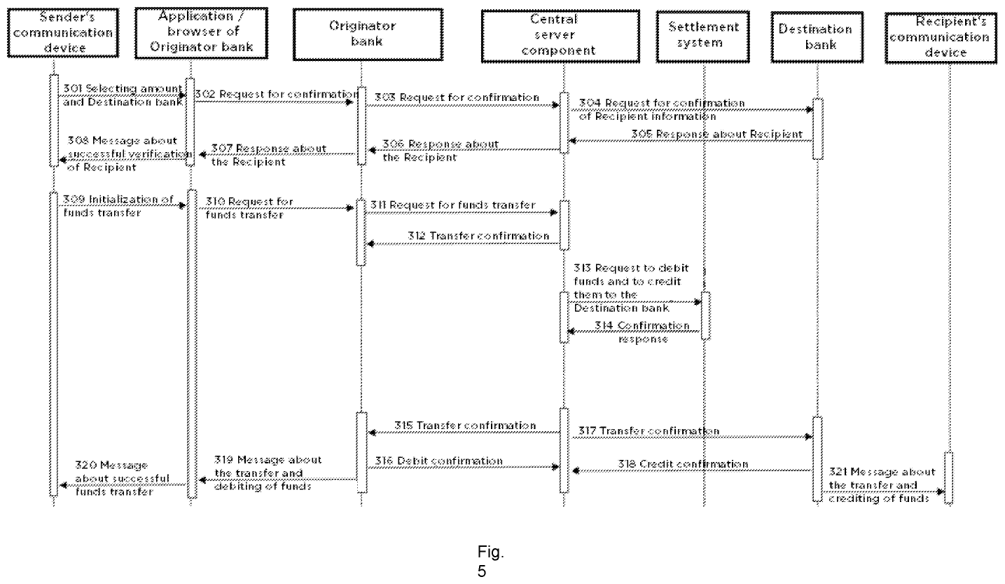

The second automated method for interbank funds transfer shown in FIG. 5 can be implemented when the Sender wishes to transfer funds quickly between their accounts in different banks. This method is a variation of the first automated method for interbank funds transfer and is also implemented on the claimed system. However, in this case the Sender is also the Recipient. In these circumstances, the Sender does not need to indicate their own settlement account with the bank for which they are also the Recipient, since the Recipient's account with this bank is determined and known to the Sender in advance.

Thus, to perform the second automated method for interbank funds transfer, the Sender, using their communication device and software installed thereon, launches the application of their Originator bank or the Originator's website via a browser and generates a request indicating their wish to transfer funds between their accounts with different banks. The Sender knows in advance with which bank they have accounts and to which bank they need to transfer funds. Due to this, the information exchange aimed at determining the Destination bank is not performed. Therefore, at the time when the Sender generates the request indicating their wish to transfer funds between their accounts, the information exchange is limited.

The Sender indicates (301) on their communication device the amount of transfer and the bank with which they have an account and wish to transfer funds to.

The Sender's communication device sends a notification (302) containing attributes of the amount and the Destination bank entered by the Sender and the attribute of funds transfer wherein the Sender is the Recipient, to the computation system of the Originator bank and then (303) to the central server component, and the central server component sends a request (304) containing the data indicated above to the Destination bank in order to receive the validation of transfer.

The computation system of the Destination bank processes the request (304) and generates the request response (305) to the central server component, which includes the information about the Recipient and their account, e.g., the Recipient's Last name, First name and Patronymic and other information about them.

The central server component creates a challenge phrase out of, for example, the First name, Patronymic and the first letter of the Last name of Recipient, which it adds to the transferred information.

This example of challenge phrase conversion is given because using the Recipient's First Name, Patronymic and the first letter of the Last name for the Sender to verify the Recipient's identity is a known verification method and it is generally accepted in the banking industry. However, over time, other methods of Recipient's identity verification may apply, and the use of new challenge phrases will not affect the implementation of claimed methods.

The central server component compares the challenge phrases of the Sender and the Recipient. This way, the central server component can additionally identify the payment as a transfer between the accounts of one individual.

If the phrases match, then transaction processing continues; otherwise, the transaction processing fails.

All of the information listed returns (306) to the Originator bank, and the software on Sender's communication device (307) receives and displays (308) the challenge phrase.

Even though the Sender and the Recipient of the funds are the same person, the stage with the display of the challenge phrase serves to reduce the likelihood of mistakes in funds transfers. Therefore, if the verification step (308) ends with the successful attribute, the Sender can proceed to the initialization of the funds transfer (309) by sending a command through the software on the Sender's personal communication device.

After this, a request for funds transfer is generated (310) to the computation system of the Originator bank which then sends it (311) to the central server component.

If the verification is passed with the successful attribute, the central server component sends a message (312) confirming readiness to perform a transaction to the Originator bank and generates a financial request (313) to the settlement system about debiting the funds from the Originator bank account and crediting them to the Destination bank account. The settlement system performs the financial request indicated by the central server component and sends a message (314) confirming its performance.

After receiving confirmation of the funds transfer request performance, the central server component sends corresponding messages (notifications) of successful transfer completion:

1. to the Originator bank (315), which, having received the confirmation from the central server component of the transfer performance and debiting of funds from its account, debits them from the account of its customer, the Sender of the transfer, and then sends the notification (316) confirming the debiting to the central server component;

2. to the Destination bank (317), which, having received the confirmation from the central server component of the funds transfer performance and their crediting to its account, credits them to the account of its customer, the Recipient, and then sends the notification (318) confirming the crediting to the central server component.

Thus, the implementation of the second automated method for interbank funds transfer also entirely excludes the possibility of “hidden” crediting of customer accounts by banks.

Then the Sender, having performed an instant transfer between their accounts, will be informed of successful transfer with corresponding messages: from the bank (319, 320) from whose account the debit was made (the Originator bank) and separately from the bank to whose account funds were credited (321).

Aside from notifications from banks, the central server component can in turn also send to the Sender acting as a Recipient a notification of funds crediting by sending a request to the computation system of the notification server. In response to the request of the central server component, the notification server sends a message to the Recipient's communication device using any method supported by its components, for example, sending a text message (in case if the Recipient has provided it earlier as a social identifier) or an e-mail (in case if the Recipient has provided their e-mail address earlier as a social identifier), as well as via other known means of communication.

Thus, the second automated method for interbank funds transfer does not require a mandatory entry of the Recipient's social identifier to determine the bank to transfer funds to the Recipient themselves, and is therefore quicker and more convenient.

However, the implementation of the first and second automated methods is done using the firmware and application and system software installed thereon, therefore the generation, exchange, verification procedures of notifications are performed at high speed. The claimed funds transfer methods include verifications that meet the industry's security standards, which allows, among other things, excluding the possibility of “hidden” crediting of customer accounts by banks. This is due to the fact that settlement is done between banks without previous accumulating of requests for transfers from senders and then forwarding them to settlement systems, but immediately for each request for transfer generated by the Sender and processed by the system.

1. Interbank funds transfer system wherein the Sender's communication device is connected via communication channels to at least one computation system of the Originator bank, configured and set up to implement methods, and the Recipient's communication device is connected via communication channels to at least one computation system of the Destination bank, configured and set up to implement methods; computation systems of Originator and Destination banks are connected via communication channels to at least one computation system of the central server component comprising at least one database, script module, interface modules to interact with each bank and interface modules to interact with the settlement system and notification service, configured and set up to implement methods and having a communication channel with the computation system of the notification service, as well as with at least one computational server of the settlement system. The difference is, the computation system of the central server component exercises control in the performance of funds transfer and sends to the settlement system requests to debit funds from the account with the Originator bank and debit them to the account with the Destination bank, the settlement system performs the funds transfer, banks' computation systems show that requests have been fulfilled on Sender's and Recipient's accounts.

2. System according to cl. 1, characterized in that the computation system of the notification service can be embedded in the computation system of the central server component.

3. System according to cl. 1, characterized in that the database is configured and set up to record, store arrays of information about social identifiers of the Recipient and identifiers of their banks;

4. System according to el. 1, characterized in that the interface modules are configured and set up to accept messages from the computation system of the Originator bank or the Recipient bank, control their integrity and check for transport errors, transmit messages to the script module, receive responses from the script module, put messages into transport format and transmit them to the computation system of the relevant bank;

5. System according to cl. 1, characterized in that the script module is configured and set up to accept messages from interface modules, verify and edit them, store the results of processing in the database.

6. Automated method for interbank funds transfer from one account to another between individuals wherein the central server component is conveyed in advance at least one social identifier of the Recipient and identifier of the bank to the account with which funds must be credited, and the central server component stores identifiers in the database; at the time of the transfer, the social identifier of the Recipient is given and transferred for identification of the Destination bank; the central server component, by processing the received messages, identifies the Destination bank and sends the message requiring Sender's confirmation, in response to which the Sender enters the transfer amount and confirms the Destination bank; a confirmation of the Recipient's social identifier at the Destination bank is requested; the Sender is provided the opportunity to verify the Recipient by showing them the corresponding challenge phrase; requests are generated and sent to the settlement system to debit funds from the Originator bank and credit funds to the account with the Destination bank, a confirmation of the request fulfillment is received from the settlement system; messages confirming the funds transfer are sent to the Originator bank and the Destination bank with a request to debit funds from the Sender's account and credit funds to the Recipient's account, and confirmations of the fulfillment are received from banks; the Sender is notified of funds debiting and the Recipient—of funds crediting from the Sender.

7. Method according to cl. 6, characterized in that computation systems of Originator and Destination banks and the settlement system interact via the central server component that performs validation procedures to authenticate the funds transfer.

8. Method according to cl. 6, characterized in that the settlement system performs funds transfers between the Originator bank and the Destination bank separately for each Sender's transfer.

9. Method according to cl. 6, characterized in that the Sender only needs to know the social identifier of the Recipient; other bank details are known to the Destination bank by default, therefore the full details of the Recipient are auto-generated after passing multi-factor authentications of computation systems of the Originator bank, the Destination bank and the computation system of the central server component.

10. Automated method for interbank funds transfer from one account to another between individuals wherein the Sender and the Recipient are the same individual, characterized in that at the time of the transfer it is communicated that the transfer is to be performed between the accounts of the same individual and the bank identifier is indicated to the Recipient's account with which funds are to be credited; the central server component, by means of processing, checks that the details of the Sender and the Recipient match and verifies that the Sender and the Recipient are the same person. After this, a confirmation of the availability of Recipient's identifier in the Destination bank is requested; requests are generated and sent to the settlement system to debit funds from the Originator bank and credit funds to the account with the Destination bank, a confirmation of the request fulfillment is received from the settlement system; messages confirming the funds transfer are sent to the Originator bank and the Destination bank with a request to debit funds from the Sender's account and credit funds to the Recipient's account, and confirmations of the fulfillment are received from banks; the Sender who also is the Recipient is notified of funds debiting from one account and of funds crediting to another account.

11. Method according to cl. 10, characterized in that computation systems of Originator and Destination banks and the settlement system interact via the central server component that performs validation procedures to authenticate the funds transfer,

12. Method according to cl. 10, characterized in that the settlement system performs funds transfers between the Originator bank and the Destination bank separately for each Sender's transfer,

13. Method according to cl. 10, characterized in that the Sender only needs to know the social identifier of the Recipient; other bank details are known to the Destination bank by default, therefore the full details of the Recipient are auto-generated after passing multi-factor authentications of computation systems of the Originator bank, the Destination bank and the computation system of the central server component.
